(19) United States
(12) Patent Application Publication
(10) Pub. No.: US 2025/0043473 A1
(43) Pub. Date: Feb. 6, 2025

(54) FIBER FILLING NONWOVEN

(71) Applicant: Far Eastern New Century Corporation, Taipei (TW)

(72) Inventors: Yi-Chen LEE, Taoyuan City (TW); Ruey-Fen LIAO, Taoyuan City (TW); Shih-Hsiung CHEN, Taoyuan City (TW); Bin Cheng WU, Taoyuan City (TW)

(21) Appl. No.: 18/773,535

(22) Filed: Jul. 15, 2024

(30) Foreign Application Priority Data
Jul. 31, 2023 (TW) 112128630

(51) Int. Cl. D04H 1/4391; D01F 6/62; D04H 1/435; D04H 1/4382; D04H 1/46

(52) U.S. Cl. CPC D04H 1/43918; D01F 6/62; D04H 1/435; D04H 1/43835; D04H 1/43914; D04H 1/46

(57) ABSTRACT

This disclosure provides a fiber filling nonwoven, consisting essentially of at least one fiber web and first fiber balls. Parts of the first fiber balls are directly fixed on the at least one fiber web, and another parts of the first fiber balls are indirectly fixed on the at least one fiber through being fixed on the parts of the first fiber balls. The first fiber ball includes first hollow polyester fibers having a first crimp number and second hollow polyester fibers having a second crimp number, and the first polyester hollow fibers and the second polyester hollow fibers are inelastic hollow polyester fibers with an elastic elongation rate equal to less than 50%. A difference of the first and the second crimp number is in a range from 4 to 10. A compression resilience ratio of the fiber filling nonwoven is equal to or greater than 80%.

### CROSS-REFERENCE TO RELATED APPLICATION

This application claims priority to Taiwan Application No. 112128630, filed Jul. 31, 2023, which is herein incorporated by reference in its entirety.

### BACKGROUND

### Field of Invention

This disclosure relates to a fiber filling nonwoven.

### Description of Related Art

Regarding the related art of fiber fillings, the main demands are mostly lightweight and good thermal resistance retention. Moreover, considering animal protection and recycling of filling materials, recyclable artificial chemical fibers are mostly used as filling materials for warmth. When developing chemical fiber filling materials, the materials with properties of down or feathers, such as lightness, thermal resistance retention, re-fluffiness after distortion and even thermal resistance retention, are hoped to imitate.

Generally, to make fiber balls have light texture, hollow fibers are selected as down-like materials. For example, a hollow fiber sphere, a fiber ball made of only a single type of hollow fibers, is disclosed in Chinese Patent No. CN107208321B. Also, the fiber ball made of the single type of hollow fiber is relatively dense, resulting in poor degree of bulkiness and poor compression resilience ratio. When the dense fiber ball is applied to fabric materials, the re-fluffiness of the fabric material is affected, and evenly the thermal resistance retention after home laundering is also affected.

To improve the compression resilience ratio of fabrics, for example, in Chinese Patent No. CN108166159B, elastic hollow fibers are used to improve the compression resilience ratio of fabrics. However, the elastic hollow fibers used in Chinese Patent No. CN108166159B is relatively expensive, which does not meet the needs of commercial mass production.

As a result, embodiments provided by this disclosure simply have to use general hollow polyester fibers to improve compression resilience ratio and degree of bulkiness of fabrics at the same time. In this way, the re-fluffiness of the fabrics can be improved and maintained the higher thermal resistance retention after home laundering.

### SUMMARY

Embodiments of this disclosure provide a fiber filling nonwoven. The fiber filling nonwoven consists essentially of at least one fiber web and a plurality of first fiber balls. Parts of the first fiber balls are directly fixed on the at least one fiber web, and another parts of the first fiber balls are indirectly fixed on the at least one fiber web through being fixed on the parts of the first fiber balls. Each of the first fiber balls comprises a plurality of first hollow polyester fibers and a plurality of second hollow polyester fibers, and the first polyester hollow fibers and the second polyester hollow fibers are inelastic hollow polyester fibers with an elastic elongation rate equal to or less than 50%. The first hollow polyester fibers have a first crimp number, and the second hollow polyester fibers have a second crimp number which is different from the first crimp number. A difference of the first crimp number and the second crimp number is in a range from 4 to 10. A compression resilience ratio of the fiber filling nonwoven is equal to or greater than 80%.

In some embodiments, a melting point of each of the first hollow polyester fibers is equal to or higher than 220° C., and a melting point of each of the second hollow polyester fibers is equal to or higher than 220° C.

In some embodiments, a denier of each of the first hollow polyester fibers is in range from 0.5 to 40 denier, and a denier of each of the second hollow polyester fibers is in a range from 0.5 to 40 denier.

In some embodiments, a thermal resistance retention rate of the fiber filling nonwoven is equal to or greater than 95%.

In some embodiments, a basis weight of the fiber filling nonwoven is in a range from 40 g/m² to 1100 g/m².

In some embodiments, the basis weight of the fiber filling nonwoven is in the range from 70 g/m² to 650 g/m².

In some embodiments, a basis weight of the first fiber balls is in a range from 30 g/m² to 900 g/m², and a basis weight of the at least one fiber web is in a range from 10 g/m² to 200 g/m².

In some embodiments, the basis weight of the first fiber balls is in the range from 40 g/m² to 500 g/m², and the basis weight of the at least one fiber web is in the range from 30 g/m² to 150 g/m².

In some embodiments, a degree of bulkiness of the first fiber balls is equal to or greater than 8000 cm³/50 g.

In some embodiments, the at least one fiber web is composed of a plurality of solid fibers, and a denier of the solid fibers is in a range from 0.8 denier to 15 denier.

In some embodiments, the at least one fiber web comprises needle-bonded nonwovens, heat-bonded nonwovens, spunbond nonwovens, melt-blown nonwovens or combination thereof.

In some embodiments, the fiber filling nonwoven further comprises a plurality of second fiber balls. Each of the second fiber balls comprises a plurality of third hollow polyester fibers and a plurality of fourth hollow polyester fibers. The third hollow polyester fibers have a third crimp number, and the fourth hollow polyester fibers have a fourth crimp number which is different from the third crimp number. A difference of the third crimp number and the fourth crimp number is in a range from 4 to 10.

In some embodiments, a compression resilience ratio of the first fiber balls is different from a compression resilience ratio of the second fiber balls.

In some embodiments, the first fiber balls are fixed to the nonwoven fiber web through mechanically needle-punching.

In some embodiments, the fiber filling nonwoven is suitable for further preparation into bedding, duvets, coats, down jackets, vests, tops, pants, hats, gloves, snow boots and scarves.

The embodiments of this disclosure provide the fiber filling nonwoven essentially consists of the fiber balls made of a fiber filling and the nonwoven fiber web. Since the fiber filling have good compression resilience ratio and degree of bulkiness, the fiber filling nonwoven not only have good compression resilience ratio and degree of bulkiness, but also maintain excellent home laundering resistance and thermal resistance retention rate after home laundering. Furthermore, the fiber filling nonwoven does not agglomerate after home laundering, so that the bedding and clothing made of the fiber filling nonwoven also have advantages of excellent thermal resistance retention, degree of bulkiness and home laundering resistance.

### BRIEF DESCRIPTION OF THE DRAWINGS

Aspects of this disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of manufacturing fiber balls according to an embodiment of this disclosure.

FIG. 2 is a cross-section diagram of hollow polyester fibers according to an embodiment of this disclosure.

FIG. 3 is a diagram of a fiber filling according to another embodiment of this disclosure.

FIGS. 4 to 6 are cross-section diagrams of a fiber filling nonwoven according to embodiments of this disclosure.

### DETAILED DESCRIPTION

References will now be made in detail to the present embodiments of the disclosure, examples of which are illustrated in the accompanying drawings. Wherever possible, the same reference numbers are used in the drawings and the description to refer to the same or like parts.

Further, spatially relative terms, such as “lower,” “beneath”, “under” or “below” and “upper,” “on,” “above” or “over” and the like, may be used herein for ease of description to describe one element or feature's relationship to another element(s) or feature(s) as illustrated in the figures. It is understandable that the relative terms are used to descried elements in different orientations than illustrated in the figures. For example, if an element in the figures is turned over, the element originally described as being “beneath” other elements is oriented “on” the other elements. The illustrative word “beneath” may include two orientations, “beneath” and “on” according to the specific orientation of the figures. Similarly, if an element in the figures is turned over, the element originally described as being “below” other elements is oriented “over” the other elements. The illustrative word “below” may include two orientations, “below” and “over” according to the specific orientation of the figures.

The words “comprising,” “including”, “having”, “containing” and the like used in this disclosure are open terms, meaning including but not limited to.

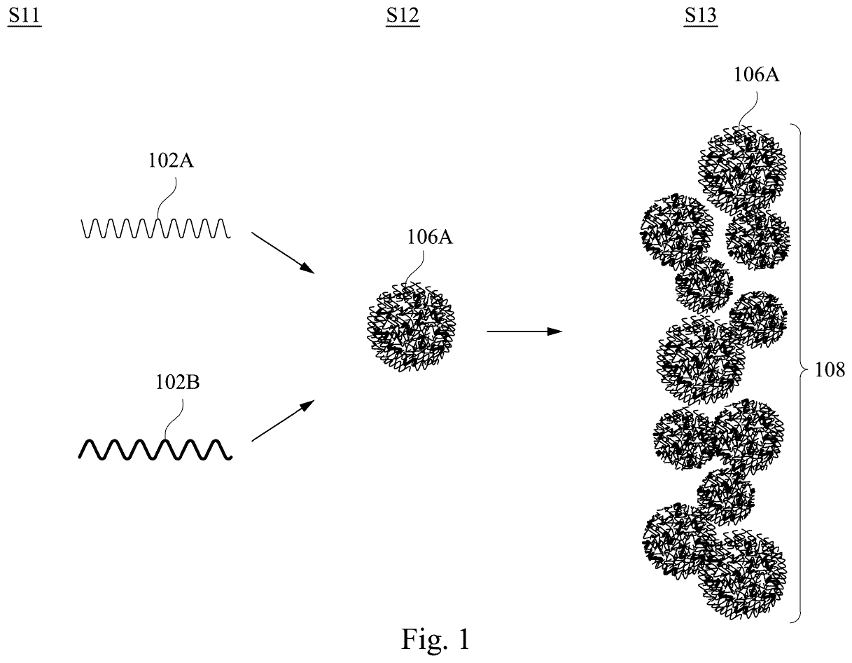

Please refer to FIG. 1. FIG. 1 is a schematic diagram of manufacturing fiber balls according to an embodiment of this disclosure. As shown in step S11, crimped hollow polyester fibers 102A and 102B are formed by being processed through a crimping machine, so that the crimped hollow polyester fibers 102A and 102B have different crimp numbers (CN) and different degrees of crimp (CD). The crimp number (CN) refers to a number of crimps per unit length of each of the hollow polyester fibers 102A and 102B. The crimp number refers to a number of crimps of the hollow polyester fibers 102A and 102B per 25 millimeters (mm). Therefore, the unit of the crimp number is no./25 mm. The degree of crimp refers to a percentage of the pre-processing length of the hollow polyester fibers 102A, 102B minus the post-processing length of the hollow polyester fibers 102A, 102B firstly, and divided by the post-processing length, the pre-processing length-post-processing length)/post-processing length*100%.

In some embodiments, the crimp number of the hollow polyester fibers 102A and 102B is respectively in a range from 8.0 to 25.0, and preferably from 11.0 to 21.0. In addition, when of the crimp numbers of either one of the hollow polyester fibers 102A and 102B is (are) less than 8, the structural stiffness of the fiber balls 106A formed of the hollow polyester fibers 102A and 102B is insufficient. In this way, the fiber balls 106A are poor in compression resilience ratio, further resulting in a low thermal resistance retention rate of the fiber filling nonwoven (such as the fiber filling nonwovens 200A, 200B, and 200C of the embodiments described below) after home laundering. The thermal resistance retention rate will be explained in the following descriptions.

A difference between the crimp number of the hollow polyester fiber 102A and the crimp number of the hollow polyester fiber 102B is (|CN₁—CN₂|=ΔCN). CN₁ refers to the crimp number of one of the hollow polyester fibers 102A and 102B, and CN₂ refers to the crimp number of the other one. In some embodiments, the difference between the crimp number (ΔCN) of the hollow polyester fiber 102A and the crimp number of the hollow polyester fiber 102B is greater than 1. In some embodiments, the difference between the crimp number (ΔCN) of the hollow polyester fiber 102A and the crimp number of the hollow polyester fiber 102B is in a range from 2 to 12. Preferably, in some embodiments, the difference between the crimp number (ΔCN) of the hollow polyester fiber 102A and the crimp number of the hollow polyester fiber 102B is in a range from 4 to 10.

Further, in some embodiments, the degree of crimp of each of the hollow polyester fibers 102A and 102B is in a range from 10.0% to 30%, and preferably form 13.0% to 22.0%. Additionally, an amount of the extensible deformation is low when the degree of crimps of each of the hollow polyester fibers 102A and 102B is less than 10%, so that the fiber balls made from the hollow polyester fibers 102A and 102B have lower compression resilience ratio.

In addition, that an elastic elongation rate of the hollow polyester fiber 102A is equal to or less than 50%, and an elastic elongation rate of the hollow polyester fiber 102B is equal to or less than 50%. That is, the hollow polyester fibers 102A and 102B are inelastic hollow polyester fibers. Also, the hollow polyester fibers 102A and 102B are not elastic fibers. Moreover, the hollow polyester fibers 102A and 102B are not low-melt binder fibers. For example, a melting point of the hollow polyester fiber 102A is in a range from 200° C. to 270° C., preferably from 230° C. to 260° C., and more specifically equal to or higher than 220° C. A melting point of the hollow polyester fiber 102B is in a range from 200° C. to 270° C., preferably from 230° C. to 260° C., and more specifically equal to or higher than 220° C. It is worth to mention that the fiber filling 108 of this disclosure is formed by fixing fiber balls 106A and 106B, made of the hollow polyester fibers 102A and 102B, to each other through a mechanical fixing process (such as mechanical needle-punch process). The purpose of using the hollow polyester fibers 102A and 102B of which the melting points are both equal to or higher than 220° C. and the mechanical fixing process is to prevent the fiber filling 108 from being roughened or hardened to further affect the tactile feeling due to heating during the production process of the fiber filling 108.

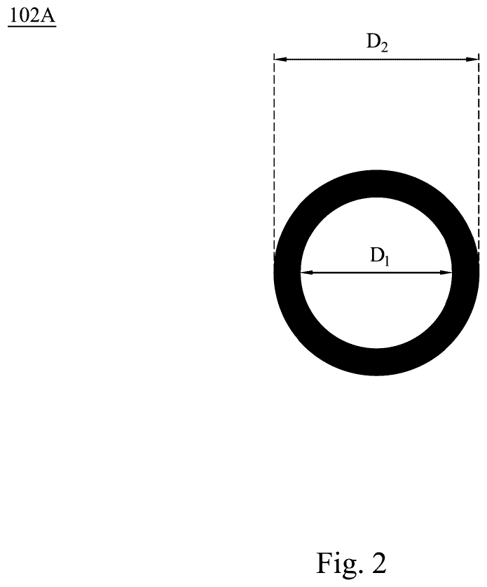

Technical features of the hollow polyester fibers 102A and 102B are further described, and please refer to FIG. 2. FIG. 2 is a cross-section diagram of hollow polyester fibers according to an embodiment of this disclosure, wherein the hollow polyester fiber 102B is simply taken as an example in FIG. 2, but this disclosure is not limited thereto. A hollowness ratio refers to (a hollow circle area/maximum outer diameter circle area)*100%. That is, taking FIG. 2 as an example, the hollowness ratio=((inner diameter D1) 2/(outer diameter D2) 2)*100%.

Moreover, although the cross-section of the hollow polyester fibers 102A and 102B shown in FIG. 2 is circular, the cross-section of the hollow polyester fibers 102A and 102B may be oval or irregular, and this disclosure is not limited thereto.

The hollow polyester fibers 102A and 102B can use the holes of the hollow fibers to increase the air content to prevent the loss of hot air, so as to improve the thermal retention effect. Therefore, the thermal retention effect is related to the hollowness ratio of the hollow polyester fibers 102A and 102B. In some embodiments, the hollowness ratio of each of the hollow polyester fibers 102A and 102B is in a range from 8% to 22%.

In some embodiments, a denier of each of the hollow polyester fibers 102A and 102B is in a range from 0.5 denier (D) to 40.0 D. When the denier of the hollow polyester fibers 102A and 102 B is less than 0.5 D, the fiber filing 108 has excellent tactile feeling, but the stiffness of the fiber filling 108 is insufficient, resulting in insufficient support of the fiber filling 108. When the denier of the hollow polyester fibers 102A and 102B is greater than 40 D, the tactile feeling of the fiber filling 108 is too rough. Also, the fiber filling 108 used for thermal retention have the disadvantage of being sparse, which is not conducive to thermal retention. In some embodiments, the denier of each of the hollow polyester fibers 102A and 102B is in a range from 0.8 D to 15.0 D. Preferably, the denier of each of the hollow polyester fibers 102A and 102B is in a range from 1.5 D to 7.0 D. In some embodiment, a denier difference between the at least two types of hollow polyester fibers 102A and 102B is in a range from 0 to 5.5.

In some embodiments, a material of the hollow polyester fibers 102A and 102B includes synthetic fibers. The hollow polyester fibers 102A and 102B of this disclosure are further selected from polyester fibers, such as petroleum-derived polyester fibers, polyester fibers containing recycled materials, biodegradable polyester fibers (such as polylactic acid (PLA)), biomass-derived polyester fibers (such as BIO-PET), combinations thereof or so on. The polyester fibers containing recycled materials are, for example, polyester fibers made from recycled PET bottle flakes or fabric recycled fiber. The petroleum-derived polyester fibers are, for example, Polyethylene terephthalate (PET), polytrimethylene terephthalate (PTT), polybutylene terephthalate (PBT) or so on. Preferably, the material of the hollow polyester fibers 102A and 102B is polyethylene terephthalate.

Then, as shown in step S12 of FIG. 1, the at least two types of hollow polyester fibers 102A and 102B are mixed and balled to form the fiber balls 106A. Additionally, the convenience of explanation, the hollow polyester fibers 102A and 102B in steps S11 and S12 are illustrated one, but there are the plurality of hollow polyester fibers 102A and 102B during production. For example, in step S13, the plurality of fiber balls 106A are made of the hollow polyester fibers 102A and 102B, the fiber filling 108 is formed by 106A.

Furthermore, in some embodiments, a length of each of the hollow polyester fibers 102A and 102B is in a range from 6 to 90 mm, preferably from 20 to 70 mm, and more preferably from 30 to 60 mm. In some embodiments, an average outer diameter of the fiber balls 106A made of the hollow polyester fibers 102A and 102B is distributed in a range from 0.5 to 15 mm, and preferably from 1 to 13 mm. Moreover, since a large number of the fiber balls 106A is produced, the size of the fiber balls 106A is defined by the “average” maximum outer diameter in some embodiments. In some embodiments, when the fiber balls 106A are spherical, the size of the fiber balls 106A is calculated based on an outer diameter of the fiber balls 106A. In some embodiments, when the fiber balls 106A are non-spherical, the size of the fiber ball 106A is calculated based on a maximum outer diameter of the fiber balls 106A.

In some embodiments, a compression resilience ratio of the fiber balls 106A made of the hollow polyester fibers 102A and 102B is equal to or greater than 74%, preferably equal to or greater than 75% to 85%, and more preferably in a range from 77% to 81%. Moreover, when the compression resilience ratio of the fiber balls 106A is less than 74%, the compression resilience ratio of the fiber balls 106A is lower. In this way, a fiber filling nonwoven (such as the fiber filling nonwoven 200A, 200B, 200C) produced in subsequent processes have a lower compression resilience ratio, which is not conducive to applications in bedding and clothing.

In some embodiments, a degree of bulkiness of the fiber balls 106A made of the hollow polyester fibers 102A and 102B is equal to or greater than 8000 cm³/50 g, and preferably in a range from 9000 cm³/50 g to 12000 cm³/50 g. The feature of degree of bulkiness of the fiber balls 106A provides good thermal insulation properties, that is, good thermal resistance retention. Moreover, when the degree of bulkiness of the fiber balls 106A is less than 8000 cm³/50 g, the fiber balls 106A become inferior lightness and voluminous feeling. In this way, the thermal resistance retention of the fiber filling nonwoven 200A, 200B, 200C made of the fiber balls 106A in the subsequent process may be reduced. The degree of bulkiness is a unit for measuring a thickness or bulkiness of fabrics, and the unit of the degree of bulkiness is cm³/50 g. The test method of the degree of bulkiness is described in detail below.

It is worth to mention that the embodiments of this disclosure provide the fiber filling 108 that has both good compression resilience ratio and degree of bulkiness to improve the re-fluffiness of fabrics (such the fiber filling nonwoven 200A, 200B, 200C). The re-fluffiness has to take into account both the compression resilience ratio and degree of bulkiness of the fiber filling 108. In other words, the fabric made of the fiber filling 108 with the better degree of bulkiness and the better compression resilience ratio also has better re-fluffiness. The various embodiments are described in detail below.

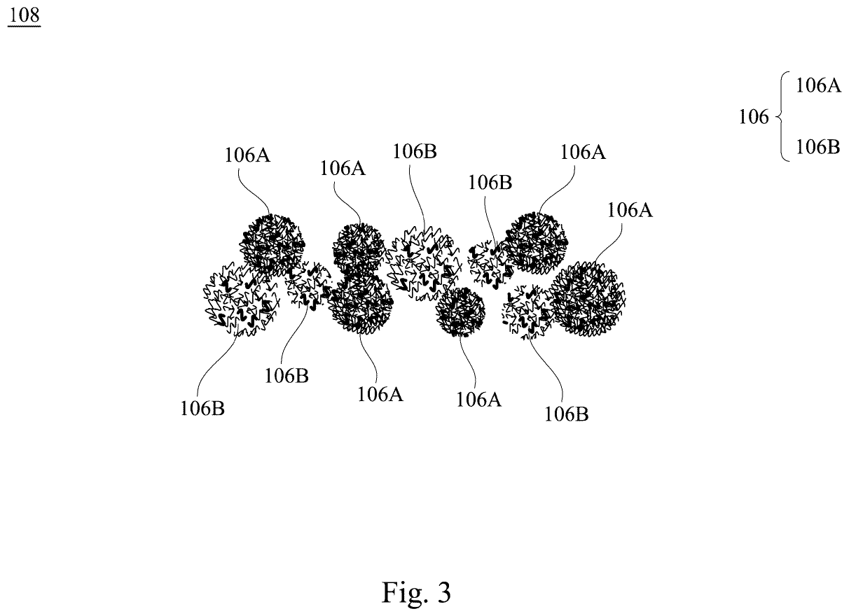

Next, please refer to FIG. 3. FIG. 3 is a diagram of a fiber filling according to another embodiment of this disclosure. In some embodiments, the fiber filling 108 further includes a plurality of fiber balls 106B. The fiber balls 106B include a plurality of at least two types of hollow polyester fibers, as shown in FIG. 3. The at least two types of hollow polyester fibers have different crimp numbers, respectively. Also, the compression resilience ratio of the fiber balls 106B is different from the compression resilience ratio of the fiber balls 106A. For convenience of description, in the embodiments described below, the fiber balls 106 include the fiber balls 106A, the fiber balls 106B or combinations thereof.

Further, the fiber filling 108 made of the fiber balls 106 is further processed into the fiber filling nonwoven 200A, 200B, 200C. However, since the fiber balls 106 are prone to displacement, in the related art, low-melt binder fibers are usually added to fix the fiber balls to each other. For example, disclosed in Chinese Patent No. CN107407027B, Japanese Patent Publication No. JP2018119240A and United States Patent Publication No. US20200270785A1, the low-melt binder fibers are used, and the fiber balls are fixed through a thermal bonding process to form fiber structures. However, the texture of the fiber structure material fixed by thermal bonding becomes hardened. Thus, the material itself has poor compression resilience ratio and poor degree of bulkiness, further affecting the re-fluffiness.

As a result, another purpose of this disclosure is to provide a fiber filling nonwoven. There is no need to add low-melt binder fibers between the fiber balls in the fiber filling nonwoven, so that the fiber filling nonwoven have good compression resilience ratio and degree of bulkiness at the same time. In this way, the re-fluffiness of fabrics can be improved, and fabrics can maintain the high thermal resistance retention after home laundering.

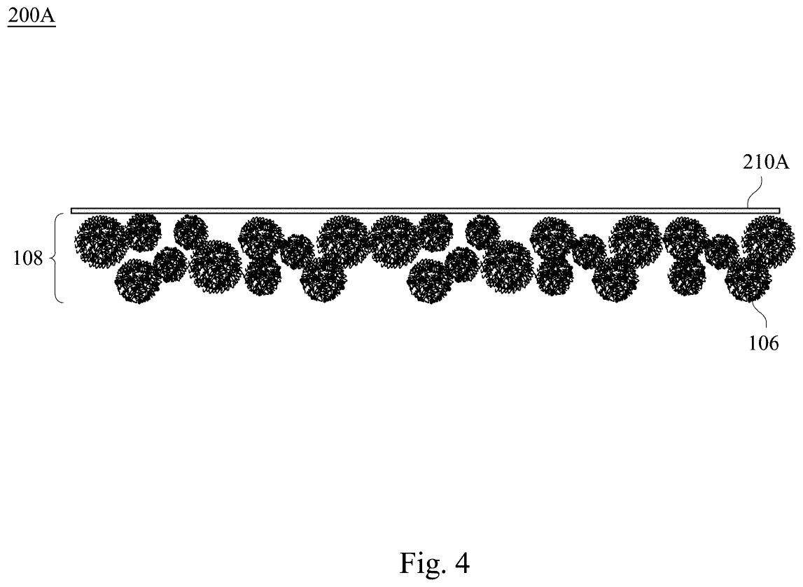

Next, please refer to FIG. 4. FIG. 4 is a cross-section diagram of a fiber filling nonwoven according to an embodiment of this disclosure. The fiber filling nonwoven 200A consists essentially of a nonwoven fiber web 210A and a plurality of fiber balls 106. In some embodiments, the fiber balls 106 include the at least two types of hollow polyester fibers 102A and 102B. The fiber balls 106 made of the hollow polyester fibers 102A and 102B and the fiber filling made of the fiber balls 106 can not only improve the compression resilience ratio of the fiber filling nonwoven 200A, but also maintain excellent home laundering resistance and thermal resistance retention after home laundering. It worth to mention that, as described above, the fiber balls 106 include the fiber balls 106A, the fiber balls 106B or combinations thereof. In addition, the processes and the technical features of the at least two types of hollow polyester fibers 102A and 102B, the fiber balls 106 and the fiber filling 108 are described above, which are not repeated here.

In addition, the fiber filling nonwoven 200A consists essentially of a nonwoven fiber web 210A and the plurality of fiber balls 106. However, other components may also be applied to the fiber filling nonwoven 200A without affecting the technical functions of the fiber filling nonwoven 200A, such as excellent compression resilience ratio, re-fluffiness, home laundering resistance and thermal resistance retention after home laundering. As well, the same applies to the subsequent fiber filling nonwoven 200B and 200C.

In some embodiments, the nonwoven fiber web 210A includes a plurality of solid fibers. A denier of the solid fibers is in a range from 0.8 D to 15.0 D, preferably from 1.0 D to 7.0 D, and more preferably 1.3 D. Additionally, when the denier of the solid fibers is less than 0.8 D, the solid fibers are difficult to card during the production process, and the stiffness of the nonwoven fiber web 210A is insufficient. When the denier of the solid fibers is greater than 15 D, the tactile feeling of the nonwoven fiber web 210A is too rough.

In some embodiments, the nonwoven fiber web 210A may include needle-bonded nonwovens, heat-bonded nonwovens, spunbond nonwovens, melt-blown nonwovens or combination thereof.

In some embodiments, the nonwoven fiber web 210A may include solid fibers, hollow fibers or irregular-shaped cross-section fibers.

In some embodiments, the nonwoven fiber web 210A includes synthetic fibers, natural fibers or combinations thereof, wherein the synthetic fibers is, for example, polyester fibers, nylon fibers or polyolefin fibers. Further, in some embodiments, a material of the solid fibers is polyester fibers, such as polyethylene terephthalate (PET), polytrimethylene terephthalate (PTT), polybutylene terephthalate (PBT), low-melt modified polyester or so on, and preferably polyethylene terephthalate.

In some embodiments, the nonwoven fiber web 210A is made of the solid fibers (such as 1.3 D of the solid fibers) to serve as a top layer or a bottom layer. In addition, the nonwoven fiber web 210A is illustrated as the top layer in FIG. 4, but the nonwoven fiber web 210A may be the bottom layer, and this disclosure is not limited thereto. Next, the fiber balls 106 mixed and balled by the at least two types of hollow polyester fibers (such as the hollow polyester fibers 102A and 102B in FIG. 1) are evenly placed under or on the nonwoven fiber web 210A. Then, in some embodiments, the fiber balls 106 and the nonwoven fiber web 210A are fixed through a nonwoven fixing process, such as binder jetting, mechanically needle-punching, ultrasonic bonding, high frequency fixing, combinations thereof or so on. In this way, the fiber filling 108 is fixed under or on the nonwoven fiber web 210A to obtain the fiber filling nonwoven 200A. In some embodiments, the preferable fixing process is mechanically needle-punching, ultrasonic bonding and/or high frequency fixing to fix the fiber filling 108 fixed in the interlayer of the fiber filling nonwoven 200A. In some embodiments, more preferably, the fixing process is mechanical needle-punch process. In this disclosure, the fiber filling nonwoven 200A is produced without using low-melt binder fibers or binder to fix the fiber balls 106 and the fiber balls 106, so that the effect on the tactile feeling of the fiber filling nonwoven 200A can be minimized or even without effect. Accordingly, due to the composition and production manner, the fiber filling nonwoven 200A can have better compression resilience ratio and re-fluffiness at the same time.

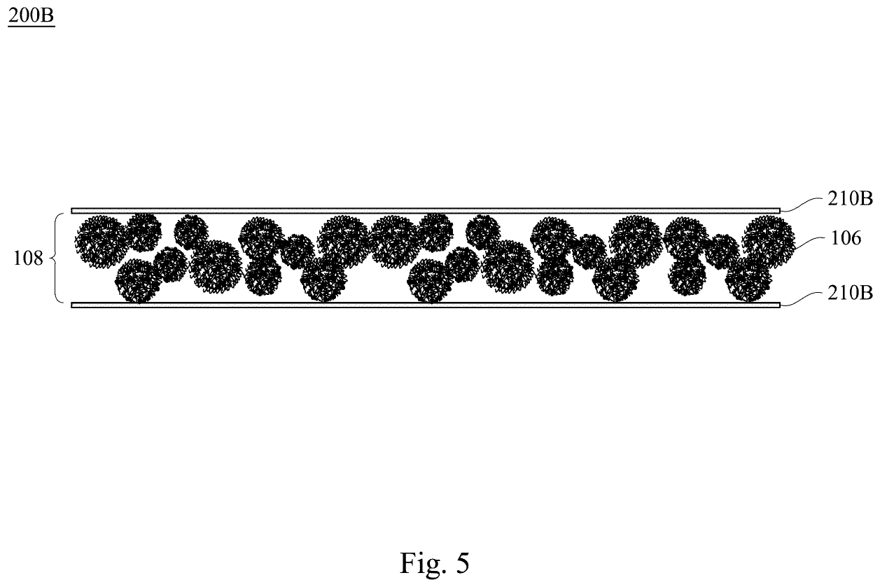

Please refer to FIG. 5. FIG. 5 is a cross-section diagram of a fiber filling nonwoven of another embodiment of this disclosure. The main difference between the fiber filling nonwoven 200B and the fiber filling nonwoven of previous embodiment is that the number of the nonwoven fiber webs 210B is at least two pieces in this embodiment. As well, the fiber filling 108 is placed between the at least two pieces of the nonwoven fiber webs 210B to obtain the fiber filling nonwoven 200B The fiber filling 108 includes the fiber balls 106. It is worth to mention that as described above, the fiber balls 106 refers to the fiber balls 106A, the fiber balls 106B or combinations thereof. The related technical features of the nonwoven fiber web 210B, the fiber balls 106, the fiber filling 108 and the nonwoven fixing process are described above, which are not repeated here.

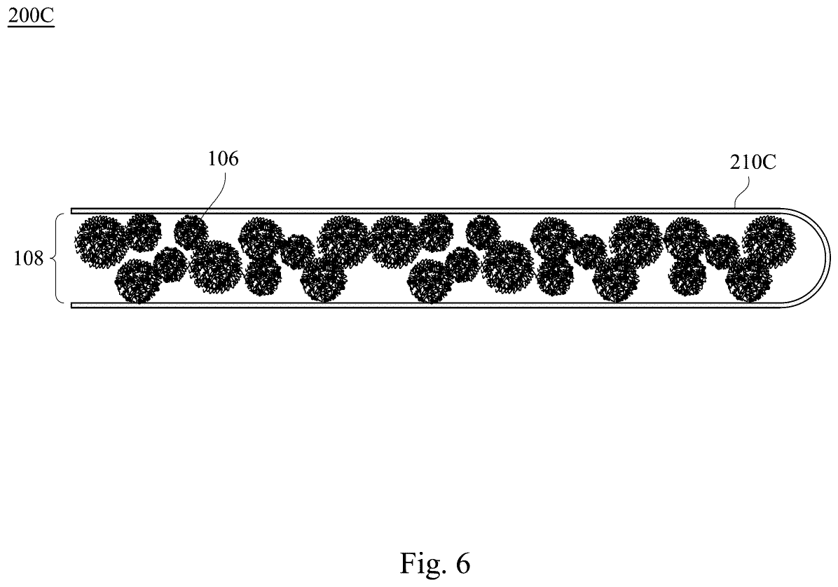

Please refer to FIG. 6. FIG. 6 is a cross-section diagram of a fiber filling nonwoven of another embodiment of this disclosure. The main difference between the fiber filling nonwoven 200C and the fiber filling nonwoven (such as the fiber filling nonwoven 200A and 200B) of previous embodiments is that the fiber filling nonwoven 200C is U-shaped in this embodiment. The fiber filling 108 is placed in the U-shape structure to obtain the fiber filling nonwoven 200C. The fiber filling 108 includes the fiber balls 106. It is worth to mention that as described above, the fiber balls 106 refers to the fiber balls 106A, the fiber balls 106B or combinations thereof. In some embodiments, the U-shaped fiber filling nonwoven 200C are connected to each other to form an S-shaped fiber filling nonwoven 200C, so as to form a multi-layer stacked structure to obtain the fiber filling nonwoven 200C with a larger basis weight. Moreover, the related technical features of the nonwoven fiber web 210B, the fiber balls 106, the fiber filling 108 and the nonwoven fixing process are described above, which are not repeated here.

Further, features of the various embodiments of the fiber filling nonwovens 200A, 200B and 200C are described below. In some embodiments, a basis weight of the fiber balls 106 is in a range from 30 g/m² to 900 g/m², and a basis weight of the nonwoven fiber web 210A, 210B, 210C is in a range from 10 g/m² to 200 g/m². Preferably, the basis weight of the fiber balls 106 is in the range from 40 g/m² to 500 g/m², and the basis weight of the nonwoven fiber web 210A, 210B, 210C is in the range from 30 g/m² to 150 g/m². More preferably, the basis weight of the fiber balls 106 is in the range from 40 g/m² to 400 g/m², and the basis weight of the nonwoven fiber web 210A, 210B, 210C is in the range from 40 g/m² to 100 g/m². In addition, when the basis weight of the fiber balls 106 is greater than 900 g/m², the fiber filling nonwoven 200A, 200B, 200C is too solid and the fiber balls 106 are stacked closely, thereby making the tactile feeling of the thermal filling too stiff. When the basis weight of the fiber balls 106 is less than 30 g/m², that is, the basis weight of the fiber balls 106 is too low, the fiber balls 106 in the fiber filling nonwoven 200A, 200B, 200C are unevenly distributed. In this way, it is prone to generate gaps in the fiber filling nonwoven 200A, 200B, 200C, resulting in reducing the thermal resistance retention.

In some embodiments, a basis weight of the fiber filling nonwoven 200A, 200B, 200C is in a range from 40 g/m² to 1100 g/m². Preferably, the basis weight of the fiber filling nonwoven 200A, 200B, 200C is in the range from 70 g/m² to 650 g/m². More preferably, the basis weight of the fiber filling nonwoven 200A, 200B, 200C is in the range from 80 g/m² to 500 g/m².

In some embodiments, a weight percentage of the fiber balls in the fiber filling nonwoven 200A, 200B, 200C is in a range from 5% to 95%, and a weight percentage of the nonwoven fiber web 210A, 210B, 210C in the fiber filling nonwoven 200A, 200B, 200C is in a range from 5% to 95%. Furthermore, when the weight percentage of the fiber balls 106 is greater than 95%, a ratio of the nonwoven fiber web 210A, 210B, 210C is too low. Thus, the nonwoven fiber web 210A, 210B, 210C is too light and thin, making the fiber filling nonwoven 200A, 200B, 200° C. unstable in structure, which is not conducive to fixing the fiber filling nonwoven 200A, 200B, 200C. When the weight percentage of the fiber balls 106 is less than 5%, a ratio of the fiber balls 106 is too low. Thus, the fiber balls 106 in the fiber filling nonwoven 200A, 200B, 200C are unevenly distributed, causing gaps in the fiber filling nonwoven 200A, 200B, 200C, which leads to reducing the thermal resistance retention. Preferably, the weight percentage of the fiber balls 106 in the fiber filling nonwoven 200A, 200B, 200C is in a range from 50% to 95%, and the nonwoven fiber web 210A, 210B, 210C in the fiber filling nonwoven 200A, 200B, 200C is in a range from 5% to 50%.

Next, various features of the hollow polyester fibers 102A and 102B, the fiber balls 106 and the fiber filling nonwoven 200A, 200B, 200C of this disclosure are described through various embodiments and various comparative examples. The manufacturing processes and features of Embodiments 1 to 8 and Comparative examples 1 to 9 are described in following paragraphs.

Firstly, please refer to Table 1 for explaining various features of embodiments of hollow polyester fibers A to F. In addition, the hollow polyester fibers A to F are polyester fibers. In addition, in subsequent descriptions about Embodiments 1 to 6 and Comparative experiments 1 to 6 will not repeat the separated features of the hollow polyester fibers A to F.

TABLE 1

| | Hollow polyester fibers | | | | | |
|---|---|---|---|---|---|---|
| Features | A | B | C | D | E | F |
| Denier (D) | 3 | 3 | 3 | 3 | 1.5 | 7 |
| Hollowness ratio (%) | 14 | 14 | 14 | 14 | 8 | 22 |
| Degree of crimp (%) | 28.1 | 22.0 | 12.3 | 13.3 | 13.1 | 22.2 |

| | |
|---|---|
| Length (mm) | 38 |
| Elastic elongation rate (%) | ≤50 |
| Melting point (° C.) | 250 |

### Embodiment 1 (Abbreviated to Emb. 1)

The hollow polyester fibers A and B are weighed with a weight ratio of 1:1 (50 gram (g): 50 g, respectively). Then, the hollow polyester fibers A and the hollow polyester fibers B are mixed and balled through a balling machine to form the fiber filling 108 of Emb. 1. The deniers of the hollow polyester fibers A and B are the same. An average crimp number (CN) of the mixed fibers is counted and calculated through extracting 45 hollow polyester fibers A and 45 hollow polyester fibers B from the fiber balls 106. A difference of the post-balled crimp number (ΔCN) of the hollow polyester fibers A and B is 4.0.

### Embodiment 2 (Abbreviated to Emb. 2)

The hollow polyester fibers B and C are weighed with a weight ratio of 1:1 (50 g: 50 g, respectively). The deniers of the hollow polyester fibers B and the C are the same. Then, a manner of producing the fiber filling 108 and a measure manner of the average crimp number (CN) of Emb. 2 are similar to the producing manner and measure manner of the average crimp number (CN) of Emb 1, and not repeated here. A difference of the post-balled crimp number (ΔCN) of the hollow polyester fibers B and C is 5.0.

### Embodiment 3 (Abbreviated to Emb. 3)

The hollow polyester fibers A and C are weighed with a weight ratio of 1:1 (50 g: 50 g, respectively). The deniers of the hollow polyester fibers A and C are the same. Then, a manner of producing the fiber filling 108 and a measure manner of the average crimp number (CN) of Emb. 3 are similar to the producing manner and measure manner of the average crimp number (CN) of Emb 1, and not repeated here. A difference of the post-balled crimp number (ΔCN) of the hollow polyester fibers A and C is 9.0.

### Embodiment 4 (Abbreviated to Emb. 4)

The hollow polyester fibers E and F are weighed with a weight ratio of 1:1 (50 g: 50 g, respectively). The deniers of the hollow polyester fibers E and F are different. Then, a manner of producing the fiber filling 108 and a measure manner of the average crimp number (CN) of Emb. 4 are similar to the producing manner and measure manner of the average crimp number (CN) of Emb 1, and not repeated here. A difference of the post-balled crimp number (ΔCN) of the hollow polyester fibers E and F is 9.0.

### Embodiment 5 (Abbreviated to Emb. 5)

The hollow polyester fibers B and Fare weighed with a weight ratio of 1:1 (50 g: 50 g, respectively). The deniers of the hollow polyester fibers B and F are different. Then, a manner of producing the fiber filling 108 and a measure manner of the average crimp number (CN) of Emb. 5 are similar to the producing manner and measure manner of the average crimp number (CN) of Emb 1, and not repeated here. A difference of the post-balled crimp number (ΔCN) of the hollow polyester fibers B and F is 6.0.

### Embodiment 6 (Abbreviated to Emb. 6)

The hollow polyester fibers E and F are weighed with a weight ratio of 1:3 (25 g: 75 g, respectively). The deniers of the hollow polyester fibers E and F are different. Then, a manner of producing the fiber filling 108 and a measure manner of the average crimp number (CN) of Emb. 6 are similar to the producing manner and measure manner of the average crimp number (CN) of Emb 1, and not repeated here. A difference of the post-balled crimp number (ΔCN) of the hollow polyester fibers E and F is 9.0.

### Comparative Example 1 (Abbreviated to Comparative Exp. 1)

The hollow polyester fibers E are weigh with 100 g. Then, the hollow polyester fibers E is mixed and balled through the balling machine to form a fiber filling of Comparative exp. 1. A difference of the post-balled crimp number (ΔCN) of Comparative exp. 1 is 0.

### Comparative Example 2 (Abbreviated to Comparative Exp. 2)

A manner of producing a fiber filling of Comparative exp. 2 through the hollow polyester fibers B is similar to the producing manner of Comparative exp. 1, and not repeated here. A difference of the post-balled crimp number (ΔCN) of Comparative exp. 2 is 0.

### Comparative Example 3 (Abbreviated to Comparative Exp. 3)

A manner of producing a fiber filling of Comparative exp. 3 through the hollow polyester fibers F is similar to the producing manner of Comparative exp. 1, and not repeated here. A difference of the post-balled crimp number (ΔCN) of Comparative exp. 3 is 0.

### Comparative Example 4 (Abbreviated to Comparative Exp. 4)

A manner of producing a fiber filling of Comparative exp. 4 through the hollow polyester fibers C and F is similar to the producing manner of Emb. 1, and not repeated here. A difference of the post-balled crimp number (ΔCN) of Comparative exp. 4 is 1.0.

### Comparative Example 5 (Abbreviated to Comparative Exp. 5)

A manner of producing a fiber filling of Comparative exp. 5 through the hollow polyester fibers D is similar to the producing manner of Comparative exp. 1, and not repeated here. A difference of the post-balled crimp number (ΔCN) of Comparative exp. 5 is 0.

### Comparative Example 6 (Abbreviated to Comparative Exp. 6)

A manner of producing a fiber filling of Comparative exp. 6 through the hollow polyester fibers E, F and low-melt binder fibers is similar to the producing manner of Emb. 1, and not repeated here. A difference of the post-balled crimp number (ΔCN) of Comparative exp. 6 is 9.0.

Next, Embodiments 1 to 6 and the Comparative examples 1 to 6 of the fiber fillings 108 of made of the various hollow polyester fibers 102A and 102B are described in Table 2A and Table 2B. Table 2A is a material property table according to Embodiments 1 to 6 of this disclosure, and Table 2B is a material property table according to Comparative examples 1 to 6 of this disclosure. The fiber filling 108 of Embodiments 1 to 6 is substantially spherical, and the basis weight of the fiber filling 108 is 150 g/m².

As shown in Table 2A and Table 2B, the degree of bulkiness is related to the thermal insulation performance. The higher degree of bulkiness, the more insulating air in the fabric contains, and thus the better thermal insulation performance. The test manner of the degree of bulkiness is as follows. The 50.0 g of the fiber filling 108 is taken and put into a hollow cylinder with an inner diameter of 16.5 centimeter (cm), and 31.0 g of a load is applied. Then, a stacking height (H) of the fiber filling 108 is measured after applying the load, and the degree of bulkiness (V) is calculated with a formula (1) as follow.

Degree of bulkiness (V)=πD²H/4 formula (1)

The compression resilience ratio is in accordance with the American Society for Testing and Materials (ASTM) D6571-01 specification for compression resilience ratio of nonwovens, and a long-term compression resilience ratio (%) of various samples is calculated. The index of the long-term compression resilience ratio (%) is defined according to AD™ D6571-01.

TABLE 2A

| | Crimp | | | | | | |
|---|---|---|---|---|---|---|---|
| Types of | number of | | | | | | |
| mixed | the mixed | Embodi- | Embodi- | Embodi- | Embodi- | Embodi- | Embodi- |
| fiber balls | fiber balls | ment 1 | ment 2 | ment 3 | ment 4 | ment 5 | ment 6 |
| HPF A | 23 | 50 | 0 | 50 | 0 | 0 | 0 |
| HPF B | 19 | 50 | 50 | 0 | 0 | 50 | 0 |
| HPF C | 14 | 0 | 50 | 50 | 0 | 0 | 0 |
| HPF D | 8 | 0 | 0 | 0 | 0 | 0 | 0 |
| HPF E | 22 | 0 | 0 | 0 | 50 | 0 | 25 |
| HPF F | 13 | 0 | 0 | 0 | 50 | 50 | 75 |

| | | | | | | |
|---|---|---|---|---|---|---|
| A difference of crimp | 4.0 | 5.0 | 9.0 | 9.0 | 6.0 | 9.0 |
| number of the post-balled | | | | | | |
| fiber balls (ΔCN) | | | | | | |
| Degree of bulkiness | 8000 | 8100 | 8200 | 10600 | 11000 | 11000 |
| (cm³/50 g) | | | | | | |
| Compression | 79 | 74 | 80 | 75 | 79 | 77 |
| resilience ratio (%) | | | | | | |

* HPF: an abbreviation of hollow polyester fibers

TABLE 2B

| | Crimp | | | | | | |
|---|---|---|---|---|---|---|---|
| Types of | number of | Compar- | Compar- | Compar- | Compar- | Compar- | Compar- |
| mixed | the mixed | ative | ative | ative | ative | ative | ative |
| fiber balls | fiber balls | Exp. 1 | Exp. 2 | Exp. 3 | Exp. 4 | Exp. 5 | Exp. 6 |
| HPF A | 23 | 0 | 0 | 0 | 0 | 0 | 0 |
| HPF B | 19 | 0 | 100 | 0 | 0 | 0 | 0 |
| HPF C | 14 | 0 | 0 | 0 | 50 | 0 | 0 |
| HPF D | 8 | 0 | 0 | 0 | 0 | 100 | 0 |
| HPF E | 22 | 100 | 0 | 0 | 0 | 0 | 40 |
| HPF F | 13 | 0 | 0 | 100 | 50 | 0 | 40 |
| Low-melt | | 0 | 0 | 0 | 0 | 0 | 20 |
| binder fibers | | | | | | | |

| | | | | | | |
|---|---|---|---|---|---|---|
| A difference of crimp | 0 | 0 | 0 | 1.0 | 0 | 9 |
| number of the post-balled | | | | | | |
| fiber balls (ΔCN) | | | | | | |
| Degree of bulkiness | 7100 | 7100 | 7300 | 6700 | 7000 | 7000 |
| (cm³/50 g) | | | | | | |
| Compression | 66 | 68 | 70 | 72 | 72 | 71 |
| resilience ratio (%) | | | | | | |

* HPF: an abbreviation of hollow polyester fibers

As mentioned above, the crimp number of the hollow polyester fibers 102A and 102B affects the amount of the extensible deformation, and further affects the compression resilience ratio of the fiber balls 106A. For example, as shown in FIG. 2, the crimp number of the hollow polyester fibers D of Comparative exp. 5 is lower (the crimp number is 8), and the compression resilience ratio of the fiber balls made of the hollow polyester fibers D is worse.

In addition, Comparative exp. 6 uses the low-melt binder fibers which are solid fibers. Due to the solid fibers, compared with the hollow polyester fibers, the amount of the extensible deformation of the low-melt binder fibers is worse. Therefore, the fiber balls made of the low-melt binder fibers and the hollow polyester fibers (such as the hollow polyester fibers E and F) have poor degree of bulkiness and lower compression resilience ratio.

Thus, compared to Comparative exps. 1 to 5 of which the differences of the post-balled crimp numbers (ΔCN)≤1, the degree of bulkiness of the fiber filling 108, made of the at least two types of hollow polyester fibers 102A and 102B of which the difference of the crimp number (ΔCN) is greater than 1, is greater than 7500 cm³/50 g, and the compression resilience ratio of the fiber filling 108 is greater than 73%. In other words, the fiber filling 108 provided by the various embodiments of this disclosure has better degree of bulkiness and compression resilience ratio. As well, since the fiber balls of the fiber filling 108 provided by the various embodiments are fixed to each other without using low-melt binder fibers, the fiber filling nonwovens 200A, 200B and 200C made of the fiber filling 108 with better degree of bulkiness and compression resilience ratio have better re-fluffiness. Further, the thermal resistance retention rate of home textile filling materials, such as pillows, down, cushions and so on, made of the fiber filling nonwovens 200A, 200B and 200C can be maintained.

Further, please refer to Table 3. Table 3 is a material property table of Preparation examples 1-1 and 1-2 and Preparation comparative example of the fiber balls 106A mixed the fiber balls 106B according to this disclosure. Preparation example 1-1 is the fiber filling 108 composed of the fiber balls 106 of Embodiment 1 and the fiber balls 106 of Embodiment 4 shown in Table 2A. Preparation example 1-2 is a fiber filling composed of the fiber balls 106 of Embodiment 2 shown in Table 2A and the fiber balls of Comparative example 5 shown in Table 2B. Preparation comparative example is a fiber filling composed of fiber balls of Comparative examples 1 and 3 shown in Table 2B. Preparation examples 1-1 and 1-2 and Preparation comparative example of Table 3 are simply as examples, and this disclosure is not limited thereto.

TABLE 3

| | | | Preparation |
|---|---|---|---|
| | Preparation | Preparation | comparative |
| Types of fiber balls | example 1-1 | example 1-2 | example |
| Emb. 1 + Emb. 4 | 1:1 | | |
| Emb. 2 + | | 1:1 | |
| Comparative exp. 5 | | | |
| Comparative exp. 1 + | | | 1:1 |
| Comparative exp. 3 | | | |
| Degree of bulkiness | 9500 | 8300 | 8000 |
| (cm³/50 g) | | | |
| Compression resilience | 81 | 79 | 67 |
| ratio (%) | | | |

As shown in Table 3, the degree of bulkiness and compression resilience ratio of Preparation examples 1-1 and 1-2 are both better. In addition, other types of fiber balls 106 are also used in the fiber filling 108 of Preparation example 1-2 in the embodiments of this disclosure, which can also achieve the effects. In Table 3, compared to the fiber balls 106 including the at least two types of hollow polyester fibers 102A and 102B with the different CN, Preparation comparative example formed through mixing two kinds of fiber balls 106 prepared from the hollow polyester fibers with single CN respectively, has poor compression resilience ratio. As well, the fiber balls 106 with better degree of bulkiness and compression resilience ratio further affect various features of the fiber filling nonwoven 200A, 200B and 200C.

Next, please refer to Table 4. Table 4 is a comparative table of fiber filling nonwoven according to various embodiments and various comparative examples of this disclosure. A nonwoven fiber web served as a top layer or a bottom layer is produced through solid fibers, such as the solid fibers with 1.3 D. Next, a fiber filling is placed evenly on or under the nonwoven fiber web. Then, the fiber filling is fixed on, below or between the nonwoven fiber webs through mechanically needle-punching to obtain a fiber filling nonwoven. Additionally, it is worth to mention that the situations of fixing the fiber filling to the nonwoven fiber web include parts of the fiber balls are directly fixed on, below or between the nonwoven fiber webs through mechanically needle-punching, and another parts of the fiber balls are indirectly fixed on, below or between the nonwoven fiber webs through being fixed on the parts of the fiber balls directly fixed on, below or between the nonwoven fiber webs due to the large number of the fiber balls on the fiber filling.

As shown in Table 4, a fiber filling nonwoven of Embodiment 7 is made of the fiber balls 106 of Embodiment 1, a fiber filling nonwoven of Embodiment 8 is made of the fiber balls 106 of Embodiment 4, a fiber filling nonwoven of Comparative example 7 is made of the fiber balls of Comparative example 4, a fiber filling nonwoven of Comparative example 8 is made of the fiber balls of Comparative example 5, and a fiber filling nonwoven of Comparative example 9 is made of the fiber balls of Comparative example 6.

TABLE 4

| | | | Compar- | Compar- | Compar- |
|---|---|---|---|---|---|
| | Emb. | Emb. | ative | ative | ative |
| Types of fibers | 7 | 8 | exp. 7 | exp. 8 | exp. 9 |
| HPF A | 50 | 0 | 0 | 0 | 0 |
| HPF B | 50 | 0 | 0 | 0 | 0 |
| HPF C | 0 | 0 | 50 | 0 | 0 |
| HPF D | 0 | 0 | 0 | 100 | 0 |
| HPF E | 0 | 50 | 0 | 0 | 40 |
| HPF F | 0 | 50 | 50 | 0 | 40 |
| Low-melting point | 0 | 0 | 0 | 0 | 20 |
| thermal binder | | | | | |
| fibers | | | | | |
| Difference of | 4.0 | 9.0 | 0 | 0 | 9.0 |
| post-balled crimp | | | | | |
| number (ΔCN) | | | | | |
| Basis weight | 220 | 220 | 220 | 220 | 220 |
| (g/m²) | | | | | |
| Compression | 83 | 87 | 79 | 78 | 79 |
| resilience ratio (%) | | | | | |
| Thermal resistance | 99 | 99 | 92 | 90 | 87 |
| retention rate (%) | | | | | |

* HPF: an abbreviation of hollow polyester fibers

In the various embodiments, the compression resilience ratio of the fiber filling nonwovens 200A, 200B and 200C obtained through the mentioned process are all greater than 80%. As mentioned above, the test method of the compression resilience ratio is based on ASTM D 6571-01. The compression resilience ratio of the fiber balls 106 affects the compression resilience ratio of the fiber filling nonwovens 200A, 200B and 200C made of the fiber balls 106. For example, the compression resilience ratio of Comparative example 7, which is made of Comparative example 4 of which the compression resilience ratio is 72%, is 79%. For another example, the compression resilience ratio of Comparative example 8, which is made of Comparative example 5 of which the compression resilience ratio is 72%, is 78%. The compression resilience ratio of Comparative examples 7 and 8 are both less than 80%. For another example, Comparative example 9, which is made of Comparative example 6 fixed through the low-melt binder fibers, has poor compression resilience ratio (less than 80%). Accordingly, the fiber filling nonwovens 200A, 200B and 200C made of the fiber balls 106 of which the compression resilience ratio is better than 73% have excellent compression resilience ratio, which is conducive to applications in bedding, clothing and so on.

Further, the thermal resistance retention rate of each of fiber filling nonwovens 200A, 200B and 200C after home laundering is tested. The test method of the thermal resistance retention rate after home laundering is based on the test standard of the thermal conductivity of fabric materials related the measurement of the thermal resistance of nonwovens of ASTM D1518-1985. Also, a method of fabrics home laundering is based on AATCC135 standard.

In some embodiments, the fiber filling nonwoven 200A, 200B, 200C is performed a home laundering test 5 times to measure changes of characteristic thermal resistance values before and after home laundering. Then, a quantitative basis for comparison of the home laundering resistance of the fiber filling nonwoven 200A, 200B, 200C is obtained.

In various embodiments, the characteristic thermal resistance retention rate of the fiber filling nonwoven 200A, 200B, 200C is equal to or greater than 95%. Furthermore, the degree of bulkiness of the fiber balls 106 also affects the thermal resistance retention rate of the fiber filling nonwoven 200A, 200B, 200C. For example, as shown in Table 4, Comparative example 7, made of the fiber balls of the Comparative example 4 of which the degree of bulkiness is 6700 cm³/50 g, has worse thermal resistance retention rate. For another example, Comparative example 8, made of the fiber balls of the Comparative example 5 of which the degree of bulkiness is 7000 cm³/50 g, has worse thermal resistance retention rate.

Additionally, Comparative examples 4 and 7 are made a cross-reference as follow. The degree of bulkiness and compression resilience ratio of Comparative example 4, made of the fiber balls containing the hollow polyester fibers with the difference of crimp number (ΔCN)≤1, are worse than the embodiments made of the fiber balls containing the at least two types of the hollow polyester fibers 102A and 102B with the different crimp numbers. Further, the fiber filling nonwoven of Comparative example 7 made of the Comparative example 4 has poor thermal resistance retention rate after home laundering. Comparative examples 5 and 8 are made a cross-reference as follow. The degree of bulkiness and compression resilience ratio of Comparative example 5, made of the fiber balls containing a single type of hollow polyester fibers (hollow polyester fibers D), are worse than the embodiments made of the fiber balls containing the at least two types of the hollow polyester fibers 102A and 102B with the different crimp numbers. Further, the fiber filling nonwoven of Comparative example 8 made of the Comparative example 5 has poor thermal resistance retention rate after home laundering. Furthermore, Comparative examples 6 and 9 are made a cross-reference as follow. The degree of bulkiness and compression resilience ratio of Comparative example 6, made of the fiber balls containing two types of the hollow polyester fibers (hollow polyester fibers E and F) and the low-melt binder fibers and fixed by thermal bonding through the low-melt binder fibers, are worse (the compression resilience ratio of Comparative example 6 is lower than 80%). Further, the fiber filling nonwoven of Comparative example 9 made of the Comparative example 6 has poor thermal resistance retention rate after home laundering. Accordingly, when the degree of bulkiness of the fiber balls 106 is less than 8000 (cm³/50 g), the fiber filling nonwoven 200A, 200B, 200C has poor thermal resistance retention rate.

Furthermore, a commercially available 3M™ Thinsulate™, thermal air fabrics, is made of polyester fibers and low-melt binder fibers and obtained through thermal air bonding. Also, the thermal resistance retention rate of the thermal air fabric tested through the same conditions of this present disclosure (performed home laundering 5 times) is low, only 60%. Accordingly, it can be further confirmed that the thermal resistance retention rate of the fiber filling nonwoven is affected by thermal bonding, resulting in the fiber filling nonwoven with worse thermal resistance retention rate. Since the hollow polyester fibers 102A and 102B of this disclosure are not low-melt binder fibers, the fiber filling nonwoven 200A, 200B, 200C has the better thermal resistance retention rate.

As shown in Table 4, in the various embodiments, the fiber filling nonwoven 200A, 200B, 200C is more resistant to home laundering. The fiber filling nonwoven 200A, 200B, 200C has the high thermal resistance retention rate after home laundering five times, greater than 95%, and evenly reaching 99%. As well, the fiber filling nonwoven 200A, 200B, 200C does not agglomerate after home laundering.

The fiber filling nonwoven 200A, 200B, 200C of the embodiments of this disclosure is suitable for further preparation into bedding, duvets, coats, down jackets, vests, tops, pants, hats, gloves, snow boots and scarves.

Additionally, as shown in FIG. 4 to FIG. 6, the fiber filling nonwoven 200A, 200B, 200C has difference forms. Through the difference forms of the fiber filling nonwoven 200A, 200B, 200C, the fiber filling nonwoven 200A, 200B, 200C and fabric using the fiber filling nonwoven 200A, 200B, 200C with different basis weights, thermal resistance retention, compression resilience ratio, degrees of bulkiness and thermal resistance retention rates after home laundering can be obtained. For example, coats can be filled with the fiber filling nonwoven 200A, 200B and/or 200C with a higher degree of bulkiness and higher compression resilience ratio to provide a softer tactile feeling. Snow boots can be filled with the fiber filling nonwoven 200A, 200B and/or 200C with higher thermal resistance retention to provide more solid snow boots.

As stated as above, the fiber filling with high compression resilience ratio and degree of bulkiness is provided by the embodiments of this disclosure. The fiber balls of the fiber filling can be fixed to the nonwoven fiber web to form the fiber filling nonwoven. In addition to excellent compression resilience ratio and degree of bulkiness, the fiber filling nonwoven can maintain excellent home laundering resistance and excellent thermal resistance retention rate after home laundering. Furthermore, the fiber filling nonwoven does not agglomerate after home laundering, so that the bedding and clothing made of the fiber filling nonwoven have excellent thermal resistance retention, degree of bulkiness and home laundering resistance.

Although the embodiments of this disclosure have been disclosed above, it is not intended to limit implements of this disclosure. Those skilled in the art can make various modifications and variations to this disclosure without departing from the scope or spirit of the disclosure. Accordingly, the scope of this can be made shall be determined by the following claims.

What is claimed is:

1. A fiber filling nonwoven, consisting essentially of:
at least one fiber web; and
a plurality of first fiber balls, wherein parts of the plurality of first fiber balls are directly fixed on the at least one fiber web, and another parts of the plurality of first fiber balls are indirectly fixed on the at least one fiber web through being fixed on the parts of the plurality of first fiber balls,
wherein each of the plurality of first fiber balls comprises a plurality of first polyester hollow fibers and a plurality of second polyester hollow fibers,
the plurality of first polyester hollow fibers and the plurality of second polyester hollow fibers are inelastic hollow polyester fibers with an elastic elongation rate equal to less than 50%,
wherein the plurality of first polyester hollow fibers have a first crimp number, and the plurality of second polyester hollow fibers have a second crimp number which is different from the first crimp number,
a difference of the first crimp number and the second crimp number is in a range from 4 to 10, and
a compression resilience ratio of the fiber filling nonwoven is equal to or greater than 80%.

2. The fiber filling nonwoven of claim 1, wherein a melting point of each of the plurality of first polyester hollow fibers is equal to or higher than 220° C., and a melting point of each of the plurality of second polyester hollow fibers is equal to or higher than 220° C.

3. The fiber filling nonwoven of claim 1, wherein a denier of each of the plurality of first polyester hollow fibers is in a range from 0.5 to 40 denier, and a denier of each of the plurality of second polyester hollow fibers is in a range from 0.5 to 40 denier.

4. The fiber filling nonwoven of claim 1, wherein a thermal resistance retention rate of the fiber filling nonwoven is equal to or greater than 95%.

5. The fiber filling nonwoven of claim 1, wherein a basis weight of the fiber filling nonwoven is 40 g/m² to 1100 g/m².

6. The fiber filling nonwoven of claim 5, wherein the basis weight of the fiber filling nonwoven is in the range from 70 g/m² to 650 g/m².

7. The fiber filling nonwoven of claim 1, wherein a basis weight of the plurality of first fiber balls is in a range from 30 g/m² to 900 g/m², and a basis weight of the at least one fiber web is in a range from 10 g/m² to 200 g/m².

8. The fiber filling nonwoven of claim 7, wherein the basis weight of the plurality of first fiber balls is in the range from 40 g/m² to 500 g/m², and the basis weight of the at least one fiber web is in the range from 30 g/m² to 150 g/m².

9. The fiber filling nonwoven of claim 1, wherein a degree of bulkiness of the plurality of first fiber balls is equal to or greater than 8000 cm³/50 g.

10. The fiber filling nonwoven of claim 1, wherein the at least one fiber web is composed of a plurality of solid fibers, and
wherein a denier of the plurality of solid fibers is in a range from 0.8 denier to 15 denier.

11. The fiber filling nonwoven of claim 1, wherein the at least one fiber web comprises needle-bonded nonwovens, heat-bonded nonwovens, spunbond nonwovens, melt-blown nonwovens or combination thereof.

12. The fiber filling nonwoven of claim 1, further comprising:
a plurality of second fiber balls, wherein each of the plurality of second fiber balls comprises a plurality of third polyester hollow fibers and a plurality of fourth polyester hollow fibers,
wherein the plurality of third polyester hollow fibers have a third crimp number, and the plurality of fourth polyester hollow fibers have a fourth crimp number which is different from the third crimp number, and
wherein a difference of the third crimp number and the fourth crimp number is in a range from 4 to 10.

13. The fiber filling nonwoven of claim 12, wherein a compression resilience ratio of the plurality of first fiber balls is different from a resilience of the plurality of second fiber balls.

14. The fiber filling nonwoven of claim 1, wherein the plurality of first fiber balls are fixed to the at least one fiber web through mechanically needle-punching.

15. The fiber filling nonwoven of claim 1, wherein the fiber filling nonwoven is suitable for further preparation into bedding, duvets, coats, down jackets, vests, tops, pants, hats, gloves, snow boots and scarves.
